(19) United States
(12) Patent Application Publication
(10) Pub. No.: US 2026/0226915 A1
(43) Pub. Date: Aug. 6, 2026

(54) ROTOR AND VACUUM PUMP

(71) Applicant: Leybold GmbH, Cologne (DE)

(72) Inventors: Benedikt Peters, Cologne (DE); Christian Berger, Cologne (DE); Ulrich Goebel, Cologne (DE)

(21) Appl. No.: 18/833,230

(22) PCT Filed: Feb. 7, 2023
(86) PCT No.: PCT/EP2023/052920

§ 371 Date: Jul. 25, 2024

(30) Foreign Application Priority Data
Feb. 9, 2022 (GB) 2201624.0

(51) Int. Cl. F04D 29/32; F04D 19/04; F04D 29/02; F04D 29/38

(52) U.S. Cl. CPC F04D 29/325; F04D 19/042; F04D 29/023; F04D 29/384

(57) ABSTRACT

A vacuum pump and a rotor preferably for a turbomolecular pump, comprising a support member connectable to a rotor shaft having a plurality of rotor blades. Therein each of the plurality of rotor blades comprises a plurality of layers perpendicular to the axial direction of the rotor, wherein each of the plurality of layers is formed at least partially as an arcuate curve connected at their respective end to the support member. The plurality of layers being arranged with a lateral offset with respect to each other.

### CROSS-REFERENCE OF RELATED APPLICATION

This application is a Section 371 National Stage Application of International Application No. PCT/EP2023/052920, filed Feb. 7, 2023, which is incorporated by reference in its entirety and published as WO 2023/152105 A1 on Aug. 17, 2023, the content of which is hereby incorporated by reference in its entirety and which claims priority of British Application No. GB2201624.0, filed Feb. 9, 2022.

### FIELD

The present invention relates to rotor preferably for a turbomolecular pump and a vacuum pump with such a rotor.

### BACKGROUND

Known vacuum pumps comprise a housing having an inlet and an outlet. A rotor assembly is disposed in the housing and rotated by an external power source such as an electromotor. At least one rotor element is attached to the rotor shaft, wherein rotation of the rotor assembly conveys a gaseous medium from the inlet to the outlet. Therein, the rotor element might be built of one or more rotor discs in particular for a turbomolecular pump. Therein, the rotor disc comprises several inclined surfaces usually built as blades in order to provide a pumping effect. Known pumps have a plurality of pump stages wherein each pump stage for the turbomolecular pump consists of at least one rotor disc interacting with at least one stator element being connected to the housing.

Due to the high rotational speed of the rotor assembly high structural requirements are imposed on the component of the rotor blade. Therein, the centrifugal forces applied to the rotor blades usually limit the rotational speed of the vacuum pump thereby at the same time limiting the maximum performance of the vacuum pump. Thus, there exists a need for rotor blades having a high structural stability.

However, increasing the structural stability of the rotor also increases the weight of the rotor assembly. This leads to higher requirements of the bearings increasing the cost of the vacuum pump. This may also limit the performance of the pump as the stored energy of the rotor will increase which may cause safety concerns.

It is well known that composite materials, especially carbon-fiber reinforced plastics (CFRP), have the potential to improve the previously named limitations drastically. While CRRP is widely used for Holweck skits in TMPs, they are not used for the turbo-bladed part of the rotors. The reason for this is the complex design and a subsequent high fabrication cost. It turned out that the connecting point between the radially oriented blades to the hub, oriented in a circumferential direction is a weak point. Mitigating this weakness increases the costs of the rotor discs as well as their weight.

The discussion above is merely provided for general background information and is not intended to be used as an aid in determining the scope of the claimed subject matter. The claimed subject matter is not limited to implementations that solve any or all disadvantages noted in the background.

### SUMMARY

In an aspect of the present invention a rotor is provided preferably for a turbomolecular pump. Often the rotor assemblies constitute of one or multiple rotor discs. The rotor disc is also known under the term bladed disc or “blisks” and forms the rotor element of one pump stage of a vacuum pump. Rotor disks of the rotor may be built individually and assembled to the rotor shaft. Alternatively, two or more rotor disks may be integrally built, preferably monolithic. The rotor disc comprises a support member connectable to a rotor shaft. Therein, the support member comprises usually a circular or almost circular opening to be connected to the rotor shaft of the vacuum pump. However, other shapes of the openings are also possible. In general, the opening of the support member has a shape conforming the shape of the rotor shaft in order to transfer rotation of the rotor shaft to the support member and consequently to the respective rotor disc. Further, the rotor disc comprises a plurality of rotor blades. Therein, each of the plurality of rotor blades comprises a plurality of layers perpendicular to the axial direction of the rotor disc.

Here and in the following, the axial direction is defined by the axial direction of the rotor shaft, i.e. coincides with the axis of rotation of the rotor. The lateral direction is a direction in a plane perpendicular to the axial direction.

The plurality of layers is arranged along the rotor shaft in an assembled condition. Therein, each of the plurality of layers for one of the plurality of rotor blades is formed at least partially as an arcuate curve, wherein the respective arcuate curve is connected at their respective ends to the support member. The plurality of layers for one rotor blade being arranged with a lateral or angular offset with respect to each other. In other words, the arcuate curve of one layer with respect to the arcuate curve of another layer of a respective blade is arranged with a circumferential offset with respect to each other. Thus, by the sequence of layers and due to the lateral or angular offset between the respective layers, angled surfaces are built which provide a pumping effect upon rotation of the rotor disc. In particular, the arcuate curves of the plurality of layers for one rotor blade are connected to each other in an axial direction in order to create a closed surface or sidewall wherein the shape of the sidewall follows the outline and the internal line of the arcuate curves of the individual layers and is inclined with respective to axial direction of the rotor disc. Thus, by the present invention the conventional blade shape of a rotor disc is altered thereby avoiding the problems of the prior art to connect such conventional rectangular rotor blades to the support member. Thus, a different design is implemented providing a high structural stability which can be easily implemented by carbon-fiber reinforced plastics or other materials.

In another aspect of the present invention a rotor is provided, preferably for a turbomolecular pump. Often the rotor assemblies constitute of one or multiple rotor discs. Rotor disks of the rotor may be built individually and assembled to the rotor shaft. Alternatively, two or more rotor disks may be integrally built, preferably monolithic. The rotor disc forms the rotor element of one pump stage of a vacuum pump. The rotor disc comprises a support member connectable to a rotor shaft. Therein, the support member comprises usually a circular or almost circular opening to be connected to the rotor shaft of the vacuum pump. However, other shapes of the openings are also possible. In general, the opening of the support member has a shape conforming the shape of the rotor shaft in order to transfer rotation of the rotor shaft to the support member and consequently to the respective rotor disc. Further, the rotor disc comprises a plurality of rotor blades.

Therein, each of the plurality of rotor blades in a cross-section in a plane perpendicular to the axial direction form at least partially an arcuate curve, wherein the arcuate curve is connected at their respective ends to the support member. The arcuate curve of a first cross-section and a second cross-section of the same blade at different positions along the axial direction being arranged with an angular offset with respect to each other. A plurality of cross-sections may be defined arranged along the axial direction. The plurality of arcuate shaped cross-sections for one rotor blade being arranged with a lateral or angular offset with respect to each other. In other words, the arcuate curve of one cross-section with respect to the arcuate curve of another cross-section is arranged with a circumferential offset with respect to each other. Thus, by the sequence of arcuate shaped cross-sections and due to the lateral or angular offset between the respective cross-sections, angled surfaces are built which provide a pumping effect upon rotation of the rotor disc.

In particular, a third cross-section may be defined, wherein along the axial direction the first, second and third cross-sections are arranged in a consecutive order, wherein the angular or lateral offset between the arcuate curve of the first cross-section and the second cross-section are in the same direction as the angular or lateral offset between the arcuate curve of the second cross-section and the third cross-section to form a continuous shape of the blade.

In particular, the arcuate curves of the plurality of cross-sections for one rotor blade are connected to each other in an axial direction in order to create a closed surface or sidewall wherein the shape of the sidewall follows the outline and the internal line of the arcuate curves of the individual cross-sections and is inclined with respective to axial direction of the rotor disc. Thus, by the present invention the conventional blade shape of a rotor disc is altered thereby avoiding the problems of the prior art to connect such conventional rotor blades to the support member. Thus, a different design is implemented providing a high structural stability which can be easily implemented by carbon-fiber reinforced plastics or other materials.

Preferably, materials with non-isotropic properties, such as better mechanical properties in one or two spatial directions are desirable for this invention.

Preferably, the arcuate curve is configured to exhibit only tensile forces that are parallel to the arcuate curve. Thus, optimal force transmission is guaranteed since forces are only applied along the direction of the highest possible strain of the material, thereby increasing the structural stability of the individual blades and the rotor disc.

Preferably, the individual layers/cross-sections of the plurality of rotor blades are arranged on common planes or arranged alternating in subsequent planes. Thus, the first layer/cross-section of one rotor blade for example is arranged in the same plane as the first layer/cross-section of another rotor blade. Alternatively, in another example, the first layer/cross-section of one rotor blade is arranged in a plane directly preceding a plane in which a cross-section of another rotor blade is arranged. By this arrangement a layer wise construction is feasible simplifying the manufacturing process.

Preferably, the rotor disc is manufactured by an additive manufacturing method such as fused filament fabrication or the like.

Preferably, at least one of the rotor blades has a varying wall thickness or density along the arcuate curve. Thus, the wall thickness may vary from a first end of the respective arcuate curve being connected to the support member to a second end of the arcuate curve along the length of the arcuate curve. Preferably, the variation is symmetric between the first end of the arcuate curve and the tip of the arcuate curve being the tip of the rotor blade. However, it is also possible that the thickness varies several times along the respective rotor blade.

Preferably, the thickness of the rotor blades is varied in order to alter the shape of the arcuate curve while maintaining only tensile forces on the arcuate curve.

Preferably, the thickness of the rotor blade is varied in such a way that the thickness is highest at the leading and/or trailing edge of the respective rotor blade and thinnest at the tip of the blade.

Preferably, the wall thickness of one rotor blade is different to the wall thickness of another rotor blade. Thus, the rotor blades can be either built similar in terms of their wall thickness or different blades may have different wall thicknesses. Thus, the wall thickness can be freely selected to increase pump performance and decrease weight of the rotor disc while maintaining structural stability of the rotor disc.

Preferably, each of the plurality of rotor blades comprise the same number of layers. Alternatively, at least two rotor blades of the plurality of rotor blades comprise a different number of layers. Therein, individual rotor blades can be built in a different way having a different structural shape to be adapted to the specific needs with respect to pump performance and structural stability.

Preferably, the lateral or angular offset of the plurality of layers/cross-sections is constant for each of the layer/cross-section. Alternatively, the lateral or angular offset between the plurality of layers/cross-sections is different and may change from one layer/cross-section to the other. Thus, by changing the lateral or angular offset between the layers/cross-sections the shape of the individual blades in the axial direction can be adapted to the specific needs with respect to pump performance and structural stability.

Preferably, the lateral or angular offset is the same for each of the plurality of rotor blades. Alternatively, at least two rotor blades implement different lateral or angular offsets from one of their layers/cross-sections to another, in particular for corresponding layers/cross-sections. Thus, individual rotor blades can be built similar with respect to their lateral offset, i.e. their axial shape, or can be built different. By the later offset inclination of the respective blades can be determined. By increasing the offset inclination is reduced. By implementing different lateral offsets for different blades, those may have different inclination adapted to the respective application in order to improve pump performance. Inclination may be defined as angle between the blade surface and a plane orthogonal to the rotational axis.

Preferably, the slope of the walls of each of the plurality of rotor blades, i.e. angle between the walls and the plane orthogonal to the rotational axis, decreases with increasing distance from the support member to the tip of the rotor blade. Thereby, the fast-rotating part of the tips of the individual rotor blades may has a different slope of the walls increasing the pump performance of the rotor disc.

Preferably, each of the arcuate curves comprises a first end and a second end connected to the support member, wherein the first end and the second end are spaced apart from each other. Thus, the arcuate curve does not end at a position where it started from the support member. Thereby a sling is created defined by the arcuate curve of the individual layers.

Preferably, the first end and the second end of the arcuate curve of one, preferably more than one and more preferably all of the blades are connected to the support member at opposite positions along the perimeter of the support member. Thus, optimal force transition of rotational forces from the individual blades to the support member is enabled and at the same time tangential connection of the individual blades to the support member can be more stable.

Preferably, each of the arcuate curves of one layer/cross-section comprises a first end and a second end preferably connected to the support member, wherein the arcuate curves of all blades of the respective layer/cross-section combinedly form a continuous line. Thus, the arcuate curves in a common layer/cross-section of all blades can be a continuous shape which can be described as a hypotrochoid or is very similar in appearance. Therein, the actuated shapes can be formed by a continuous fiber of a fiber reinforced plastics, for example. In other words, the second end of a first blade coincides with the first end of another blade and so on until the second end of the last blade coincides with the first end of the first blade. Therein, preferably at the position of coinciding first ends of one blade and second end of another blade, the transition is free of any kink, i.e. have the same slope/curvature. In other words, the first derivative at the first end of one blade is equal or almost equal to the derivative at the second end of the other blade. Therein, in particular, the respective arcuate curves may extend along an outer surface of the support member in order to increase to surface of contact between the blades and the support member. In other words, the first end of one blade may be connected respectively to the second end of another blade by intermediate section, wherein the intermediate section may form the support member. The intermediate section may extend along the shape of the support member and the combination of all intermediate sections or all layers/cross-sections combinedly may form the support member. This combination of arcuated curves shows increased durability and strength and is at the same time simple to manufacture.

Preferably, the ratio between the number of tips/slings/blades n∈ [symbol] to the number of turns to trace the complete shape k∈ [symbol] (this can be determined by counting the crossings of the shape or line forming all the arcuate curves of the blades with a line that starts at the axis of rotation going radially outwards) lies in the interval of

$$\frac{1}{2} < \frac{k}{n} < \frac{1}{\sqrt{3}} ,$$

e.g. 4/7, 5/9, 6/11 . . . .

Preferably, each of the arcuate curves comprises a first end and a second end connected to the support member, wherein the first end and the second end are of one blade are directly connected by the respective first end and second end of an opposite blade. Thus, the arcuate curves of two opposite blades are directly connected such that their forms can be combinedly built by a continuous sling. Alternatively, the arcuate curves of two opposite blades are connected by an intermediate section, wherein the intermediate section may form the support member. In other words, the second end of a first blade is connected to the first end of an opposite second blade by the intermediate section, and the second end of the second blade is connected to the first end of the first blade by an intermediate section. The intermediate section may extend along the shape of the support member and the combination of all intermediate sections or all layers/cross-sections combinedly may form the support member.

Preferably, each of the arcuate curves comprises a first end and a second end connected to the support member, wherein the first end and the second end are at the same axial positions. Thus, the arcuate curve does end at the same axial position or axial height where it started from the support member. In particular, the individual layers of each of the arcuate curves is perpendicular to the axis of rotation.

Preferably, each of the arcuate curves comprises a first end and a second end connected to the support member, wherein the first end and the second end are at different axial positions. Thus, the arcuate curve does not end at the same axial position or axial height where it started from the support member. Thereby a sling is created defined by the arcuate curve of the individual layers. In particular, the individual layers of each of the arcuate curves is tilted around an axis perpendicular to the axial direction. Thus, the shape of the resulting blades can be adapted to the specific needs thereby performance of the rotor may be optimized.

Preferably, reinforcement element in each of the blades follow the arcuate curve. In particular, projection of the reinforcement elements in each of the blades projected onto a plane perpendicular to the axial direction/axis of rotation follow the arcuate curve.

Preferably, for one rotor blade at least one layer/cross-section, preferably more than one and most preferably all layers/cross-sections have a parabolic or nearly parabolic shape. Therein, the shape of the arcuate curve is defined by a parabolic function to ensure that the tensile forces are parallel to the arcuate curve. In particular, if the first end and the second end of the respective arcuate curve are at different axial positions, the axial projection of the arcuate curve has a parabolic shape or nearly parabolic shape. Therein, the axial projection is defined as projection along the axial direction of the rotor shaft.

Preferably, for one rotor blade at least one layer/cross-section, preferably more than one and most preferably all layers/cross-sections have a catenary or nearly catenary shape. Therein, the shape of the arcuate curve is defined by a catenary function to ensure that the tensile forces are parallel to the arcuate curve. Therein, the catenary function is usually proportional to a cosh-function. In particular, if the first end and the second end of the respective arcuate curve are at different axial positions, the axial projection of the arcuate curve has a catenary shape or nearly catenary shape. Therein, the axial projection is defined as projection along the axial direction of the rotor shaft.

Preferably, for one rotor blade at least one layer/cross-section, preferably more than one and most preferably all layers/cross-sections have a troposkein or nearly troposkein shape. Therein, the shape of the arcuate curve is defined by a troposkein function to ensure that the tensile forces are parallel to the arcuate curve. Therein, the troposkein function is usually proportional to the Jacobian elliptical sine-function (denoted by “sn” and also called the sinus amplitudinis). In particular, if the first end and the second end of the respective arcuate curve are at different axial positions, the axial projection of the arcuate curve has a troposkein shape or nearly troposkein shape. Therein, the axial projection is defined as projection along the axial direction of the rotor shaft.

Preferably, for one rotor blade at least one layer/cross-section, preferably more than one and most preferably all layers/cross-sections have a hypotrochid or nearly hypotrochoid shape. Therein, the shape of the arcuate curve is defined by a hypotrochoid to ensure that the tensile forces are parallel to the arcuate curve. In particular, if the first end and the second end of the respective arcuate curve are at different axial positions, the axial projection of the arcuate curve has a hypotrochoid shape or nearly hypotrochoid shape. Therein, the axial projection is defined as projection along the axial direction of the rotor shaft.

Preferably, for one rotor blade at least one layer/cross-section, preferably more than one and most preferably all layers/cross-sections have a symmetric shape, which is mirrored along a line that is orthogonal to the axial direction and connects the axis of rotation and the point of the shape that is furthest from the rotational axis. The length of the shape on either side of the mirror axis can but does not need to be of equal length.

Preferably, each blade is at least partially made from fiber reinforced plastics (FRP), such as carbon- or glass-fiber FRP. In particular, the rotor, i.e. the rotor disk is completely made from FRP.

Preferably, the rotor, i.e. the rotor disk is monolithic.

Preferably, the arcuate curve can be built by slings or long fibers. More preferably continuous fibers can be used. Alternatively, closed slings of material can be used increasing the structural stability of the individual blades.

Preferably, the fibers are arranged along the respective arcuate curves. Thereby optimal force transmission from the tip of each blade to the support member is guaranteed.

Preferably, the projections of fibers onto the respective cross-section are arranged along the arcuate curves.

Preferably, each of the plurality of layers is at least partially made from bands of metal. Bands of metal or metal bands comprise an increased stability in one or two directions (perpendicular to the width of the band). In addition, bands of metal comprise a high ability to withstand tensile forces applied along the length of the band material. Thus, each layer may be created by bands of material connecting the individual layers to each other in order to create the shape of the individual blades.

Preferably, the arcuate curve of the plurality of rotor blades overlap or are spaced apart from each other in plane perpendicular to the axial direction or on the surface of a mathematical cone with circular symmetry whereby the axis of rotation of the rotor coincides with the line of symmetry of the cone. Thus, the arcuate curve of one rotor blade may be separate and spaced apart from the arcuate curve of another neighboring rotor blade. Alternatively, neighboring rotor blades may overlap.

Preferably, the length of the arcuate curve may vary within one rotor blade from one layer/cross-section to another layer/cross-section. Thereby, the radial extension of the individual blades can be tailored to the specific needs. Alternatively, the length of the arcuate curve may be fixed for all layers/cross-sections of one blade.

Preferably, the shape of the arcuate curve can vary from one layer/cross-section of one particular rotor blade to another layer/cross-section thereby adapting the shape of the individual rotor blades in the axial direction.

Preferably, all blades of one rotor disk are identically shaped. Alternatively, at least two rotor blades are built different in their respective shapes.

In another object of the present invention a vacuum pump is provided comprising at least one rotor disc as described before. Therein, the rotor disc is connected to a rotor shaft of the vacuum pump and rotated preferably by an electromotor. Thereby, the rotor disc is interacting with stator elements connected to a housing of the vacuum pump in order to provide a pumping effect and convey a gaseous from an inlet to an outlet of the vacuum pump.

Preferably, the vacuum pump comprises a plurality of rotor discs as described before in particular each of them interacting with an individual stator. Therein, the plurality of rotor discs may be built identical, or the shape of the rotor disc may change.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with respect to the accompanying drawings.

The figures show:

FIG. 1 a vacuum pump in accordance with an embodiment of the present invention,

FIGS. 2A to 2C exemplified details of the rotor discs according to the present invention,

FIGS. 3A and 3B different embodiments of a detailed view of the rotor disc cross-section, layer or layer projection according to the present invention,

FIGS. 4A and 4B different views of an embodiment of the present invention,

FIGS. 5A and 5B different views of another embodiment of the present invention,

FIGS. 6A and 6B different views of another embodiment of the present invention,

FIG. 7 a flow diagram of a method for manufacturing according to the present invention.

### DETAILED DESCRIPTION

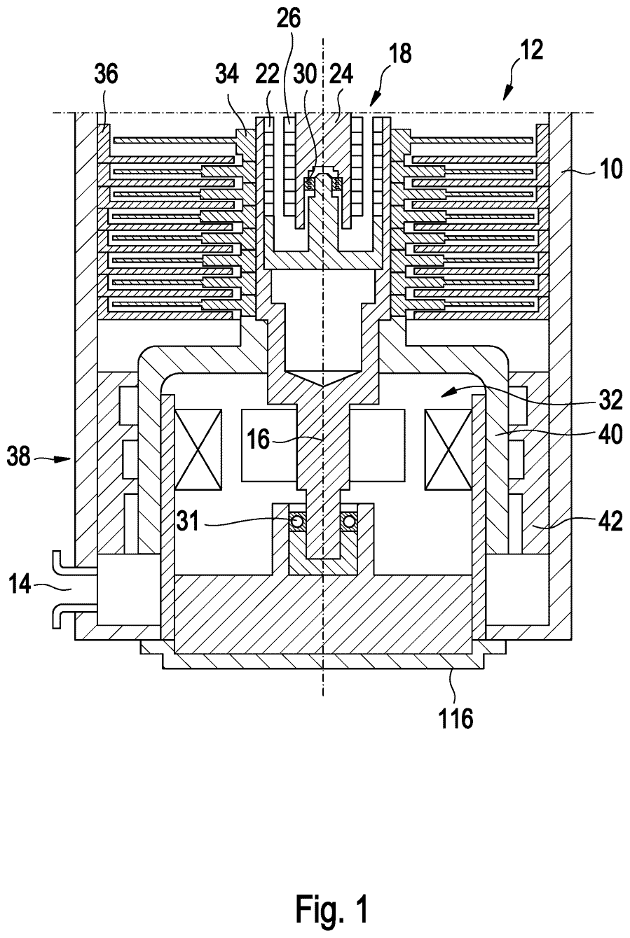

Referring to FIG. 1 showing a vacuum pump built as turbomolecular pump. The vacuum pump comprises a housing 10 including an inlet 12 and an outlet 14. A rotor shaft 16 is disposed in the housing and supported by a first radial bearing 18 built as permanent magnetic bearing in the example of FIG. 1, and a mechanical ball bearing 31. The first radial bearing 18 comprise a plurality of magnet rings 22, 23. Therein the static magnet rings 26 of the radial bearing 18 are attached to a trunnion 24 extending into a recess of the rotor shaft 16. The rotated magnet rings 22 are arranged at the inner surface of the recess radially next to the static magnet rings 26.

Further, the radial bearing 18 comprise emergency running bearings 30 (upper) built as ball bearings. The rotor shaft 16 is driven by electromotor 32. Attached to the rotor shaft 16 are a plurality of pump elements built as rotor disks 34 interacting with stator elements 36 connected to the housing 10 of the vacuum pump and arranged alternating with the rotor disks 34. In addition, the vacuum pump of FIG. 1 comprises a Holweck stage 38 comprising a rotating cylinder 40 interacting with a threated stator 42 connected to the housing. By rotating of the rotor shaft 16 a gaseous medium is conveyed from the inlet 12 of the vacuum pump towards the outlet 14.

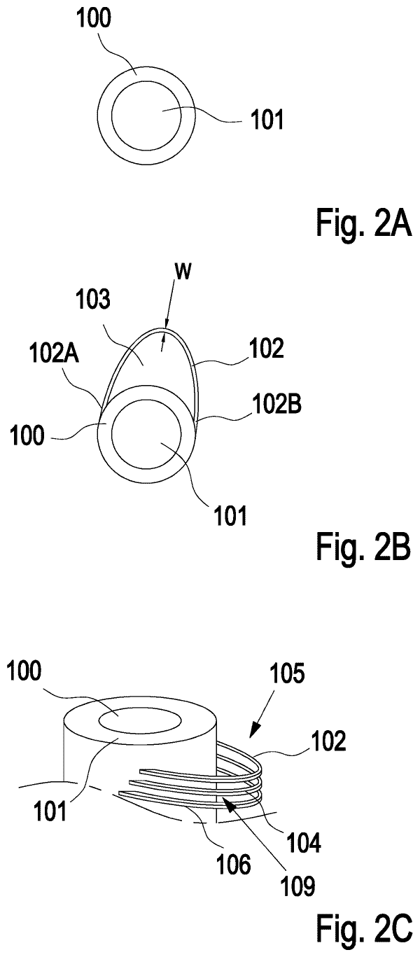

Referring to FIGS. 2A-2C. According to the present invention the rotor disc 34 comprises a support member 100 having an angular or almost angular opening 101. The support member 100 can be attached to the rotor shaft 16 of the rotor assembly in order to connect the rotor disc 34 or blade disc to the rotor shaft 16. Referring to FIG. 2B showing a detailed view of the rotor disc 34. To the support member 100 in a first layer an arcuate curve 102 is attached therein a first end 102A of the arcuate curve 102 and the second end 102B are attached to the support member 100 and being distant from each other. The arcuate curve has a defined width W providing the thickness of the sidewalls and creating and enclosing an opening 103. Further, the arcuate curve has a defined height in the axial direction. Thereby, the arcuate curve 102 in the first layer builds a part of the sidewall or inclined wall providing the pump effect of the rotor disc. As shown in FIG. 2C the arcuate curve 102 of the first layer is repeated in a second subsequent layer to provide a second arcuate curve 104 which is axially shifted in relation to the arcuate curve 102 of the first layer and arranged with a lateral or angular offset with respect to the arcuate curve 102 of the first layer. Further, FIG. 2C shows a third arcuate curve 106 in a third layer. Therein, in the FIGS. 2B and 2C only one rotor blade is shown for simplicity and illustration purposes. However, the blade disc may comprise a plurality of rotor blades. By the arcuate curves 102, 104, 106 in the different layers being connected to each other a sidewall or solid surface is created providing a pump effect when rotating the rotor disc in the vacuum pump. Therein, the sidewall can be built stepwise providing a stepped inclined wall. Alternatively, the sidewall can be continuous providing a smooth surface. Therein, each rotor blade comprises a plurality of layers. Although in FIG. 2C the number of layers is exemplified as 3 for simplicity and illustration purposes, the number of layers may be above 20, preferably above 50 and more preferably above 100. By the subsequent layers a continues connection of the respective arcuate curves is provided. In particular, no space is in between the individual subsequent layers and their respective arcuate curves to form a closed surface for pumping.

In other words and in particular for the case that the rotor is not built layer by layer, cross-sections in a plane perpendicular to an axial direction can be considered as layer. Therein, the axial direction corresponds with the axial direction of the rotor shaft and the axis of rotation. As described before and with respect to the layers, on each cross-section the blade is built by an arcuate curve such as arcuate curves 102, 104, 106 as shown in FIG. 2A to 2C. Consequently, in the following, layers may be replaced by cross-sections.

In particular, if the rotor is made from long-fiber, thin strip or continuous fibre-reinforced material, the projection of this reinforcement onto a plane orthogonal to the axis of rotation, follows the shape of the arcuate curves described by the present invention.

Although shown in FIGS. 2B and 2C that the thickness of the sidewalls created by the arcuate curve 102, 104, 106 is constant, i.e. W as indicated in FIG. 2B is constant along the complete arcuate curve, in different embodiments the thickness of the sidewalls created by the arcuate curves 102, 104, 106 may vary along the individual arcuate curves 102, 104, 106 or may vary from one layer to another layer providing an increasing or decreasing wall thickness in the axial direction.

Further, FIG. 2C shows that the length and shape of the arcuate curves 102, 104, 106 are identical. However, in different embodiments either the length of the arcuate curves 102, 104, 106 or the shape or both may vary from one layer to another in order to adapt the shape of the blade 105 in the axial direction.

The shape of the arcuate curves 102, 104, 106 may be provided by a parabolic function. Alternatively, the arcuate curves have a shape provided by a catenary including cosh-function or might be provided by a troposkein or very similar shapes. By the specific selection of the shape of the arcuate curves 102, 104, 106 it is enabled that all tensile force introduced to the specific blades 105 due to rotation of the rotor disc are parallel to the arcuate curve and thus parallel to the direction of highest possible tensile forces of the material. Thus, if the arcuate curve is for example built by fiber-reinforced plastics, fibers and in particular long or continues fibers or even closed fiber loops are running along the arcuate curve providing a structural stability in the direction of the tensile force, thereby enhancing the structural stability of the rotor blade. As a consequence, higher rotational speeds can be applied to the specific rotor blades increasing the pump performance. Thus, by deviating from the conventional blade design of a rectangular blade being connected to an annular support structure a stable and easy to fabricate rotor disc can be achieved. Upon rotation of the rotor disc as exemplified by the arrow 107 in FIG. 2C the inclined surfaces 109 provide a pumping effect to the particles of the gaseous medium towards the outlet of the vacuum pump.

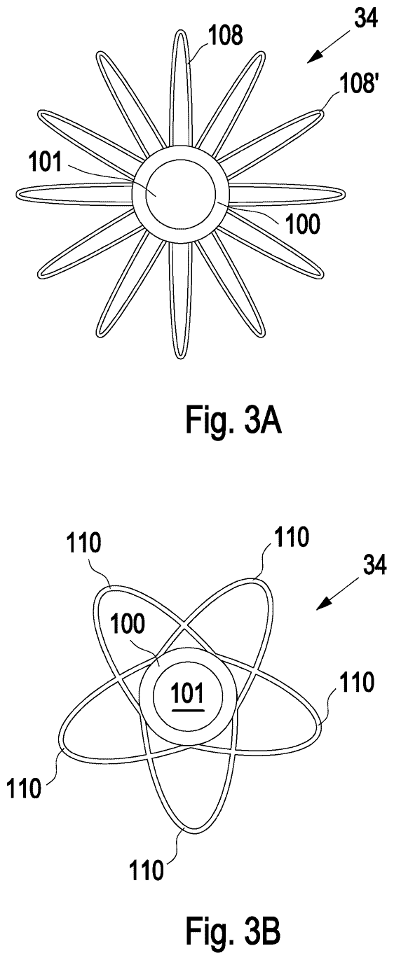

FIG. 3A shows a first embodiment wherein rotor blades 108, 108′ are exemplified by their arcuate curves. In particular, the rotor disc of FIG. 3A may have more than six rotor blades, more than ten rotor blades or the like. However, in the embodiment of FIG. 3A the arcuate curves of the individual rotor blades 108, 108′ are not intersecting with each other and being connected to the support member 100 distant from each other.

In another embodiment shown in FIG. 3B being exemplified with five blades 110 being evenly distributed around the support member 100 wherein the arcuate curves of the rotor blades 110 of the embodiment are intersecting with each other.

Although shown in FIGS. 3A and 3B that the individual rotor blades 108, 108′, 110 may have the same size and shape, of course different rotor blades may have different sizes and shapes in order to provide an optimized pump effect by the individual inclined surfaces of the rotor disc.

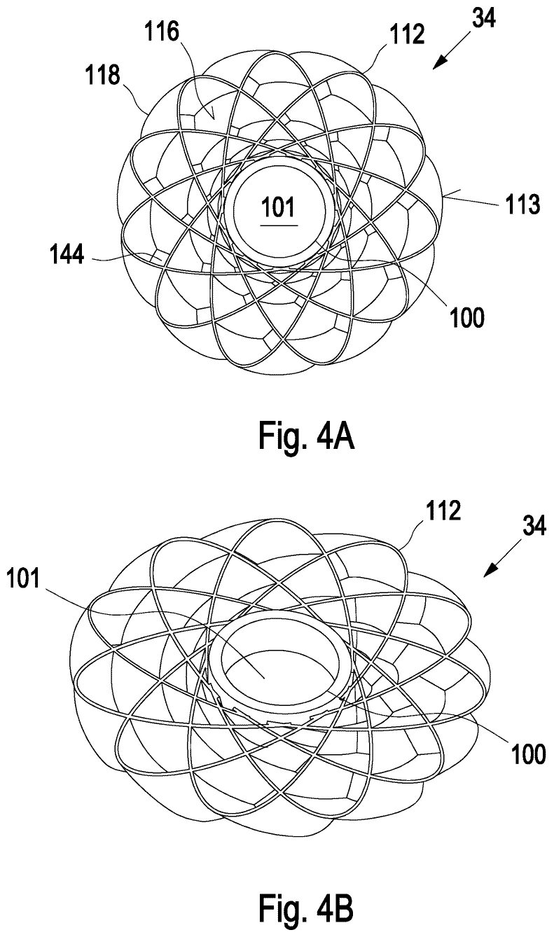

Referring to FIGS. 4A and 4B showing a full rotor disc 34 of another embodiment having eleven blades 112 in two projections. Therein, the thickness of the sidewalls is selected to be constant at a thickness of 0.1-5 mm, preferably 0.5-2 mm. Further, by the blades a plurality of openings 144 are created having inclined surfaces 116 providing a pump effect on the particles of the gaseous medium. Therein, the inclined surfaces 116 have in the example of FIGS. 4A and 4B an inclination of between 10° to 65° and preferably between 10° to 20° with respect to the axial direction. Further, as shown in FIG. 4A, the outer rim 113 of the rotor disk 34 is almost circular preventing backstreaming of the gaseous medium in the vacuum pump between the individual pump stages. However, if the number of blades is decreased, filling elements can be provided between the blades to ensure a circular or at least almost circular correction of the rotor disk 34 thus that the outer rim is in close proximity to the housing of the vacuum pump in an assembled condition.

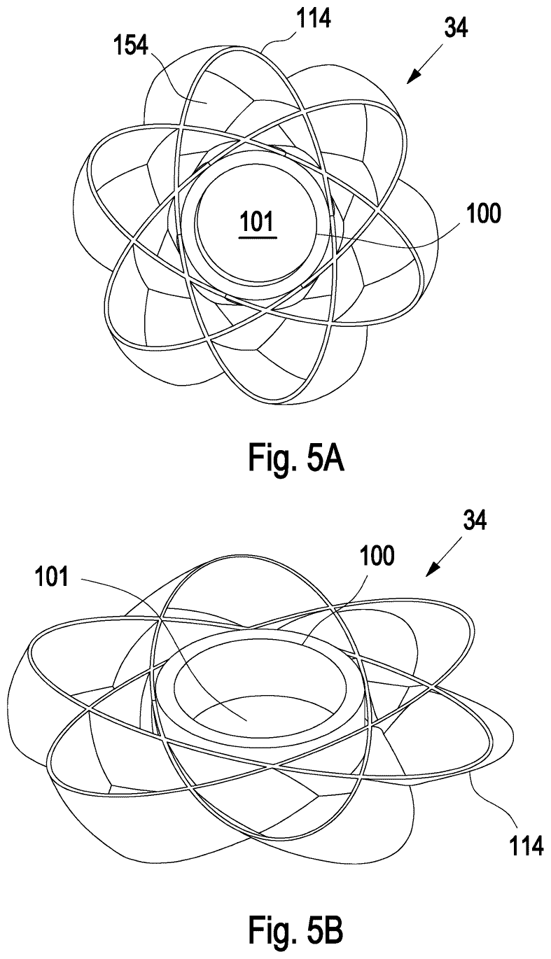

Referring to the embodiment of FIGS. 5A and 5B showing a rotor disk according to the present invention having only six blades 114 providing inclined surfaces within the plurality of openings 154 wherein the inclined surfaces having inclination of between 10° to 65° and preferably between 15° to 30° with respect to the axial direction to provide an optimal pumping efficiency. Therein, the arcuate curve of one blade connects seamless to the arcuate curve of an opposite blade in a layer or cross-section. Thus, reinforcement elements used for creating the blades 114 can be provided as slings simultaneously providing two opposite blades.

Preferably, the axial width of the rotor disc is between 1 mm and 35 mm and preferably between 5 mm and 15 mm. The outer diameter of the rotor disc is preferably between 50 mm and 400 mm and more preferably between 70 mm and 300 mm.

As shown in FIGS. 4A, 4B, 5A and 5B, the rotor disk may be made from carbon-fiber reinforced plastics (CFRP) including preferably long and more preferably continues fibers to create the arcuate curves of the individual layers. Therein, even closed slings can be used for the example of FIGS. 5A and 5B to create the opposing rotor blades at once.

Preferably, in order to manufacture the respective rotor blades additive manufacturing methods can be used, in particular fiber reinforced fused filament fabrication. Therein, the arcuate curves of each blade of the first layers are placed in common plane and manufactured in a first step. Subsequently, the arcuate curves of all blades in the subsequent layer are fabricated and thus the respective rotor disc can be manufactured layer by layer. In particular, in order to further enhance structural stability of the rotor disc when using continues carbon-fibers or even closed slings of carbon-fibers, these carbon-fibers can be woven in particular at the intersection points of the individual blades.

Preferably, in order to manufacture the respective rotor blades a filament winding process can be used. Therein a one or multi part mandrel is used to wind the material into the desired shape. Contrary to commonly used filament winding processes this mandrel may be not be fully convex in winding direction. The fabrication of these rotor blades that require concave mandrels may need more than two axes of motion between the filament source and the mandrel.

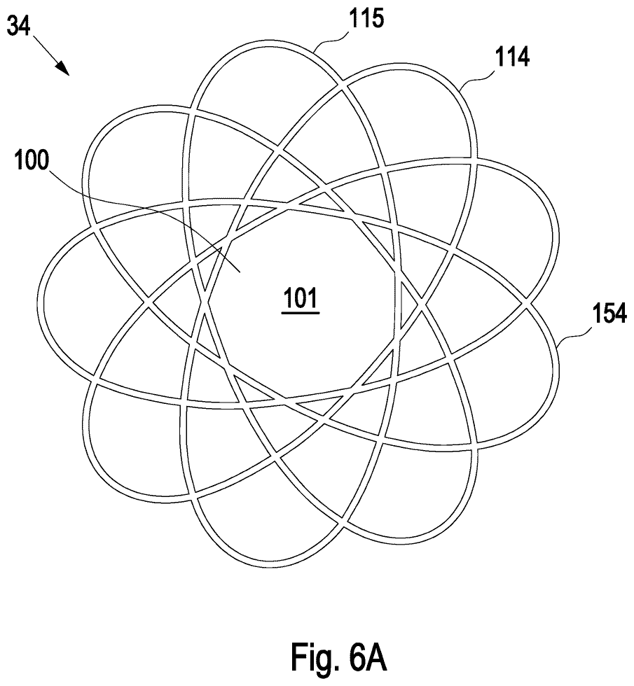

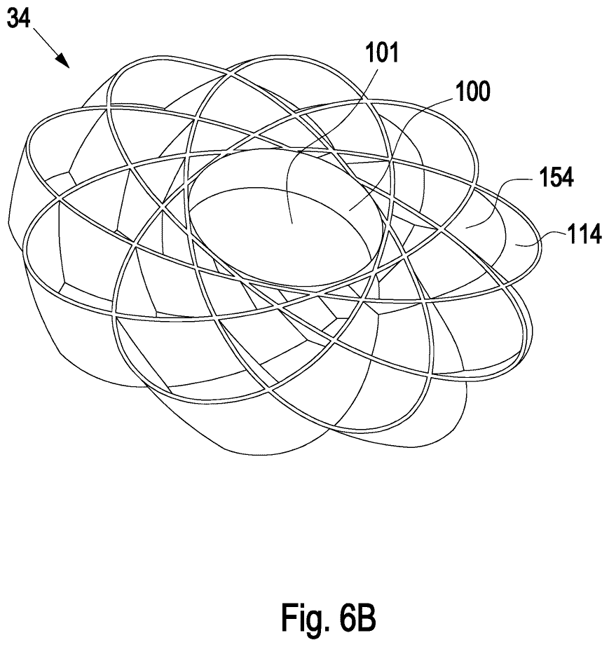

Referring to the embodiment of FIGS. 6A and 6B showing a rotor disk according to the present invention having nine blades 114 providing inclined surfaces within the plurality of openings 154, wherein the inclined surfaces having inclination of between 10° to 65° and preferably between 15° to 30° with respect to the axial direction to provide an optimal pumping efficiency. In FIG. 6A is shown the combined arcuate curve of one common layer or cross-section. As shown, the arcuate curves combine together to a single line. Endpoint of one blade is the starting point of another blade until endpoint of the last blade is the starting point of the first blade. Therein, the curve can be characterized resembling a hypotrochoid or following substantially a shape similar to a hypotrochoid. Reinforcement elements can be provided as continuous sling building all blades together. Thereby load balancing within the rotor is improved increasing the durability and strength of the rotor. FIG. 6B shows a perspective view of the rotor of FIG. 6A.

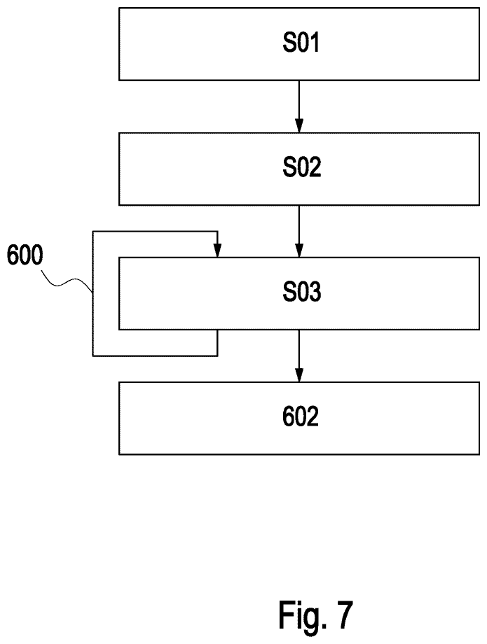

Referring to FIG. 7 showing a flow diagram of a method to manufacture a blade disc according to the present invention. The method has the steps:
S01: providing a support member to connect the rotor disc to the rotor shaft;
S02: providing an arcuate curve for each of the rotor blades of the rotor disc;
S03: repeating the arcuate curves of the first layer, in a subsequent layer, in an angular offset with respect to the preceding layer; and
S04: in accordance with the arrow 600, step S03 is repeated several times such that layer by layer the rotor disc is created in order to acquire the final rotor disc 602.

As already indicated before, neither the arcuate shapes of the individual blades as provided in step S02 need to be identical nor the repeated arcuate shapes in different layers as provided in step S03 need to be identical and may be adapted in a length, sidewalls thickness or shape of the respective arcuate curves in order to increase either stability of the rotor disc, pump performance or both.

Thus, by deviating from the conventional form of the rotor disc and in particular their blades, structural stability can be enhanced and thus higher rotational speeds can be applied to the rotor without damage. Alternatively, this concept can be utilized to produce rotor blades with lower mass and/or lower second moment of inertia, which will allow increased rotational speed. Alternatively, this concept can be used to utilize material that could not be used for impellers due to their mechanical strength in at least one spatial direction. In particular, the connection point between the individual blades and the support member are improved since the arcuate curves are configured such that tension are always or at least substantially parallel along the arcuate curve in the direction of the highest strength of the material.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A rotor, preferably for a turbomolecular pump, comprising
a support member connectable to a rotor shaft having an axial direction,
a plurality of rotor blades,
wherein each of the plurality of rotor blades in a cross-section in a plane perpendicular to the axial direction form at least partially an arcuate curve, wherein the respective arcuate curve is connected at their respective ends to the support member, and
wherein the arcuate curve of a first cross-section and a second cross-section of a respective blade being arranged with an angular offset with respect to each other.

2. A rotor preferably for a turbomolecular pump, comprising
a support member connectable to a rotor shaft,
a plurality of rotor blades,
wherein each of the plurality of rotor blades comprises a plurality of layers,
wherein each of the plurality of layers is formed at least partially as an arcuate curve, wherein the arcuate curve is connected at their respective ends to the support member, and
the plurality of layers of a respective blade being arranged with an angular offset with respect to each other.

3. The rotor according to claim 1, wherein at least one of the rotor blades has a wall thickness varying along the arcuate curve and/or is different for at least two layers of the same rotor blade and/or different for at least two cross-sections of the same rotor blade.

4. The rotor according to claim 1, wherein each of the plurality of rotor blades has walls with constant thickness or at least two rotor blades of the plurality of rotor blades have walls with different thickness.

5. The rotor according to claim 1, wherein the angular offset of the plurality of layers is constant or the angular offset of the plurality of layers is different.

6. The rotor according to claim 1, wherein the slope of the walls of each of the plurality of rotor blades decreases with increasing distance from the support member to the tip of the respective rotor blade.

7. The rotor according to claim 1, wherein each of the arcuate curves comprises a first end and a second end connected to the sup-port member, wherein the first end and the second end are spaced apart from each other.

8. The rotor according to claim 1, wherein each of the arcuate curves comprises a first end and a second end, wherein the arcuate curves of all blades combinedly form a continuous line, wherein first end of one blade is connected to the second end of another blade preferably by intermediate section, wherein the intermediate section may form the support member.

9. The rotor according to claim 1, wherein each of the arcuate curves comprises a first end and a second end, wherein the arcuate curves of opposite blades combinedly form a continuous line, wherein first end of one blade is connected to the second end of another blade preferably by intermediate section, wherein the intermediate section may form the support member.

10. The rotor according to claim 1, wherein the arcuate curve has a substantially parabolic form.

11. The rotor according to claim 1, wherein the arcuate curve has a substantially catenary form.

12. The rotor according to claim 1, wherein the arcuate curve has a substantially troposkein form.

13. The rotor according to claim 1, wherein the arcuate curve has a substantially hypotrochoid form.

14. The rotor according to claim 1, wherein each of the plurality of layers is at least partially made from fibre-reinforced plastics, FRP, material, especially a carbon- or glass fiber reinforcement.

15. The rotor according to claim 14, wherein the FRP material comprises continuous fibers or closed slings of material.

16. The rotor according to claim 1, wherein each of the plurality of layers is at least partially made from bands of metal.

17. The rotor according to claim 1, wherein the arcuate curves of the plurality of rotor blades overlap or are spaced apart from each other in the plane perpendicular to the axial direction.

18. The rotor according to claim 1, wherein one or more of a length and a shape of the arcuate curves of each of the plurality of layers of one rotor blade varies.

19. A vacuum pump with a rotor or at least one rotor disc according to claim 1.
